(19) United States
(12) Patent Application Publication
(10) Pub. No.: US 2019/0156267 A1
(43) Pub. Date: May 23, 2019

(54) Systems and Computer-Implemented Methods for Assigning Services and Workforce

(71) Applicant: Ha X Nguyen, Algonquin, IL (US)

(72) Inventor: Ha X Nguyen, Algonquin, IL (US)

(21) Appl. No.: 16/195,734

(22) Filed: Nov. 19, 2018

Related U.S. Application Data
(63) Continuation-in-part of application No. 16/184,978, filed on Nov. 8, 2018.
(60) Provisional application No. 62/588,373, filed on Nov. 19, 2017.

(51) Int. Cl. G06Q 10/06

(52) U.S. Cl. CPC G06Q 10/063112; G06Q 10/0633

(57) ABSTRACT

A service assignment network and associated methods are disclosed. The service assignment network having at least a manager device, the manager device housing a manager service assignment application, and the manager service assignment application allowing a manager to select a client, a workstation, an employee, and a service and communicate the selections to the service assignment network; and an employee device in communication with the manager device, the employee device housing an employee service assignment application, the employee service assignment application allowing an employee to accept or reject selections made by the manager service assignment application, and the employee service assignment application causing the employee device to provide visual indicators to indicate whether the service has been completed.

### RELATED APPLICATIONS

This application claims the benefit of provisional application 62/588,373 filed 19 Nov. 2017 and the benefit of U.S. nonprovisional application Ser. No. 16/184,978 filed 8 Nov. 2018.

### FIELD OF THE INVENTION

The present invention generally relates to an invention in the field of service management. More particularly, this invention disclosed herein relates to the field of devices and methods that are used for managing employees' job performance, service assignment, workforce assignment, and work hours.

### BACKGROUND

In small business owners often focus more on marketing and sales, relying mostly on their employees performing services for clients. More specifically, in beauty (nail, hair, etc.) and massage businesses, most employees are independent contractors. Frequently this means that the independent contractors will compete among themselves for clients. Further, they can exploit most modern systems to get to the next clients in line by skipping procedural steps to shorten working time to complete the requested services.

In the beauty and massage business, many services are pricing based on time of performance. For example, $30 can be priced for 30 minutes of massage. Currently, beauty salons use manual timers; these timers do not work, particularly when there are clients waiting in line. Employees ignore the timers and/or set the time to only 25 minutes, instead of 30 required. These behaviors cause many internal issues, customer dissatisfaction, and reduced quality. In addition, proprietors can face ethical and moral dilemmas as well as the possibility for legal action.

Typical beauty and massage businesses have a workspace that must be allocated (typically around 1500 square feet). In this small space it can contain about 26 workstations, including 16 spa chairs, 10 working tables, 1 facial room, 1 massage room, 1 restroom, and about 12 employees. Thus, during some times of the day there are about 45 people including clients in this small salon. This results in a crowded and noisy workplace that is difficult for even the most skilled managers to manage.

Further, workstations at the beauty and massage salons are sometimes equipped with electronic devices for clients—not for employees. Those owners of the business have no choice, having to use manual timers for managing their employees performing services. Tasks or services in the context of beauty and massage business include, for example, pedicures, manicures, acrylic nail sets, massages.

Thus, to summarize, there are several problems that beauty and massage salons face daily. The behaviors cause many internal issues, ethical and moral; customer dissatisfaction; and reduced quality. These issues include: 1) Crowded, noise and high foot traffic in small workspace; 2) Low productivity due to time spent to find technicians and technicians spending time to obtain information about the service assigned to them; 3) Employees lack of customers' information beforehand; 4) Lack of tools to record customers' information; 4) Customers cannot make payment at the workstation; 5) Employees cannot immediately obtain a report of their performed services as desired; and 6) Independent employees/contractors are in a hurry to compete for next clients.

Other inventions and attempts have been made to solve this problem, a survey of which are presented below.

US PGPUB 2002/0145559 by Sullivan disclosed a time and location keeper for employees includes a device which includes a power supply, a smart GPS receiver, and a data transmitter such as a cell phone. The components are worn on the person, for example in a compartmented belt. Time and location data are sent to a base station from the transmitter, which may be activated automatically on a schedule, or by a query signal from the base station.

U.S. Pat. No. 5,204,663 by Lee disclosed an access control system, and a method of controlling an access to a controlled area, comprising an integrated-circuit card key having contact pads and a sufficient memory capacity to store key access information and transaction information, information in the integrated circuit integral therein at respective addresses, and an acceptor which includes a memory to store lock access information, and circuitry for reading the key and lock access information, whenever the contact pads of the key is electrically engaged with the acceptor, comparing the key and lock access information, providing a control signal to the opening mechanism of an access controlled area based on a comparison, result and recording transactional information from the lock into the integrated circuit of the key at respective addresses.

U.S. Pat. No. 6,415,284 by D'Souza et al. disclosed fields of smart forms include default logic and verification logic to simplify filling in of the smart form by an employee and reduce the likelihood that errors in data entry occur. In particular, the default logic determines a default value for a field in the form according to one or more data items in a comprehensive company database. Verification logic verifies that the employee has entered valid form data in a particular field. The verification logic can include references to data items stored in the comprehensive company database such that data entered by the employee can be verified with respect to data already stored in the database. Data entered by the employee is stored in the database and can be used by default logic and/or verification logic in subsequently used smart forms.

U.S. Pat. No. 6,581,025 by Lehman disclosed a time and work tracker that automatically collects and analyzes information about time and work performed on a wireless device is described herein. According to the present invention, a time and work tracking function is initiated on a wireless device. Thereafter, a user begins to perform work on the wireless device. As the user works, the tracking function on the wireless device collects data relating to the activities performed by the user. The collected data is then analyzed to determine what types of work the user has actually performed.

In addition there are some tools available for human resource management including point of sale (POS) systems from Clover and Square. However no POS systems are available that provide methods of services and workforce assignment as disclosed herein.

Accordingly, there is a market this present invention of systems and computer implemented methods for assigning services and workforce consisting of systems, computer-implemented methods, and computer applications capable of providing managing employees' service performance. This will reduce unnecessarily tension at workplace, improve quality of lives, and importantly growing business. These features, and others, of the Smart Timer Device are disclosed herein and discussed in greater detail below.

### BRIEF SUMMARY

Currently-available devices, as discussed above, therefore currently do not use a novel system as described herein. This design is both interesting and easily useable, two important features in the modern market.

To resolve the limitations discussed above, this invention herein discloses systems and computer-implemented methods for automatically and manually assigning services and workforce.

Various embodiments of the present invention herein provided teach how to assign services and workforce using the systems and the methods disclosed herein. In an embodiment of the invention, the systems and methods display a service assignment screen interface. The interface includes information and icon buttons for workstations, services, employees, clients, and functional features. The interface is used by personnel for assigning services. In another embodiment, the systems and methods assign services by itself, without personnel involved, basing on information provided: clients, workstations, employees' skills and availability.

Also disclosed is a system, a computer-implemented method, and a computer application in the present invention provide for presenting visual indication for a period of time required by a service. According to the present disclosure, a smart timer device ensures an employee stays on his/her job until the device's indicator is turned off by the device. For example, a client contracts for a massage for 45 minutes: an employee starts performing the service, and at the same time, a smart timer device turns an indicator (a LED) on. The indicator stays on for 45 minutes and the employee then must perform the service for the client until the LED is turned off by the device—not by the employee. The visual indicator of the LED ensure the client's satisfaction that he/she has received what they have paid for.

In one implementation, the present disclosure of a smart timer device provides a method of presenting visual indication for a period of time required by a service to a service performer, including receiving a service message with a value of time via a WIFI network, turning an indicator (LEDs) on for a period of time required by a service, turning the indicator(s) off as the time elapsed.

In an aspect of the present disclosure, a smart timer device is a computer, including, but not limited to, a processor, memory, user interface, indicators, input/output interface, communication network, universal serial bus, memory card interface, power supply. The indicators include, but are not limited to, LEDs, displays, and touch screens. The communication network includes, but not is not limited to, WIFI, Bluetooth, ethernet, and cellular networks. The memory cards include, but are not limited to, SD cards, ROM, and RAM. The user interface includes, but is not limited to, switches, touch screens, and sensors. The power supply includes, but is not limited to, AC-DC power adapter, and batteries.

In other embodiments, using a service assignment screen interface and systems and methods configured as manual mode, a manager assigns a service by selecting a client button, then selecting a service button, then selecting a workstation button, then selecting an employee, then click “Assign” button. The systems and methods then send out two different electronic messages via a communication network: one to the selected employee to notify him/her that there is a service for him/her to perform right away and the other to the selected workstation. The message to the employee is displayed on his/her smart phone, for example. The message includes information related to the service, such as service's type, customer's name, performance time, start time, workstation's name, and the like. The systems and methods also ask the employee to confirm the assigned service in the form of “Yes” or “No” reply. The message may be sent using a number of different mechanisms according to various embodiments, such as electronic mail, text messaging, streaming media, and/or some other type of electronic communication. The message to the selected workstation includes information related to the service, such as performance time required by the service. The message may be sent in such formats as text-digitized message and/or some other type of electronic communication required by a computer device at the workstation. The systems and methods communicate with this device at the workstation to make sure that the device will behave as directed via the message.

An additional feature of the present disclosure can be that after reading an assigned service message, the assigned employee replies with a “No.” Then the manager can make service assignment again to another available employee. If a “Yes” reply received, the systems and methods, on screen, present indications on the selected workstation and start the digital countdown timer embedded on the workstation. Another feature allows a manager to cancel a service already assigned by clicking the “Cancel” button then selecting a workstation assigned for the service.

Additionally a method is provided for assigning a service to an employee. According to the method, if the systems and methods are configured as auto mode, the systems and methods assign services automatically by itself. No manager needed, the systems and methods perform service assignment as that of the manager described above: selecting a service, a workstation, an employee, sending out messages to the employee and the workstation and waiting for reply from the employee and the workstation, and reassigning service if a reply “No” from the employee. After assigned a service, systems and methods involve waiting for a reply from the assigned employee for a pre-defined period of time, said 2 minutes. On manual mode, if no reply received after this period of time, the systems and methods present no-reply indication on service assignment screen. In auto mode, the systems and methods can automatically re-assign the service. The systems and methods further can involve sending a service-waiting message to manager, if there is a service waiting to be assigned for more than a pre-defined period of time, for instance, 5 minutes. These systems and methods basically remind manager that clients are waiting to be served.

The systems and methods further involve presenting indicators on a service assignment screen of occupied workstations, available workstations, assigned employees, available employees, time remaining of a service being performed. This helps manager knowing how much time left for a service being served by an employee. Further the disclosure teaches a user interface on an employee's computer device. The user interface may include buttons representing workstations, services, and functions. Employees may use this user interface to submit selections of services and workstations to managers, send receipt information to managers, retrieve sales history, make notes about clients, get help, and cancel services. A message may be in a form of yes and no question. An employee may reply with an answer by selecting yes or no, then the employee's computer device sends that answer back to the sender.

It is also contemplated that messages for requests may be sent ahead of time for may be on time. Therefore several specific embodiments of the present disclosure are contemplated below.

In a first embodiment a service assignment network composed of: a manager device, the manager device housing a manager service assignment application, and the manager service assignment application allowing a manager to select a client, a workstation, an employee, and a service and communicate the selections to the service assignment network; and an employee device in communication with the manager device, the employee device housing an employee service assignment application, the employee service assignment application allowing an employee to accept or reject selections made by the manager service assignment application, and the employee service assignment application causing the employee device to provide visual indicators to indicate whether the service has been completed.

In a second embodiment the disclosure contemplates a method for assigning services having: starting service assignment mode; selecting an available workstation using a manager device; selecting an available employee on the manager device; assigning a service to the employee on the manager device; sending a service message to the employee on the employee device, the service message inquiring whether the employee accepts the service, the employee selecting from the group consisting of: Yes and No; returning to selecting an available employee in the event the employee selects: No; sending the workstation an indication message; presenting indications on a service assignment screen on the employee device; inquiring whether service execution time has expired; stopping presentation and saving service information if service execution time has expired.

Reference is made therefore to the claims herein for interpreting the full scope of the invention. Other objects of the present invention, as well as particular features, elements, and advantages thereof, will be elucidated or become apparent from, the following description and the accompanying drawing figures.

### DESCRIPTION OF THE DRAWINGS

The present invention may be better understood, and its numerous objects, features, and advantages made apparent to those skilled in the art by referencing the accompanying drawings.

FIG. 1 is a view of an embodiment of a user interface Manager Service Assignment application software product according to the present disclosure.

FIG. 2 is a view of an embodiment of a user interface Employee Service Assignment application software product according to the present disclosure.

FIG. 3 is a schematic diagram showing an exemplary system architecture and structure according to the present disclosure.

FIG. 4 is an exemplary block diagram of a Manager Device used by a business manager to assign services according to the present disclosure.

FIG. 5 is an exemplary block diagram of an Employee Device used by a business employee to communicate with a manager according to the present disclosure.

FIG. 6 is a block diagram is an illustration of one embodiment of a Workstation Device at a workstation to communicate with a Manager Device according to the present disclosure (aka smart timer device).

FIG. 7 is an illustration of an embodiment of a user interface of an Employee Device displaying the user interface Service Assigned Message according to the present disclosure.

FIG. 8 is an illustration of an embodiment of a Service Receipt according to the present disclosure.

FIG. 9 is an illustration of an embodiment of a user interface of an Employee Device displaying a sales history according to the present disclosure.

FIG. 10 is an illustration of an embodiment of a user interface of an Employee Device displaying a text area and an operational feature button for saving the notes according to the present disclosure.

FIG. 11 is an illustration of an embodiment of a user interface of a Manager Device displaying an Employee Reply Message according to the present disclosure.

FIG. 12 is an illustration of an embodiment of a user interface of a Workstation Device displaying a Workstation Service Message according to the present disclosure.

FIG. 13 is an illustration of an embodiment of an electronic message showing the data structure of a service assigned message according to the present disclosure.

FIG. 14 is an illustration of one embodiment of an electronic message showing the data structure of a workstation indication message according to the present disclosure.

FIG. 15 is an illustration of one embodiment of an electronic message showing the data structure of an employee service reply message according to the present disclosure.

FIG. 16 is an exemplary flow chart of a method of manually assigning services and workforce by a user according to the present disclosure.

FIG. 17 is an exemplary flow chart of a method of automatically assigning services and workforce by a by a Manager Service Assignment application according to the present disclosure.

FIG. 18 is an exemplary flowchart of a method of receiving, by an Employee Device, service assigned messages from a Manager Service Assignment application according to the present disclosure.

FIG. 19 is an exemplary flowchart of a method of submitting, by an Employee Device, service requested messages to a Manager Device according to the present disclosure.

FIG. 20 is an illustration of an exemplary electronic message showing the data structure of a service requested message according to the present disclosure.

FIG. 21 is an exemplary flowchart of a method of receiving, by a Manager Device, service requested messages from an Employee Device according to the present disclosure.

### DETAILED DESCRIPTION

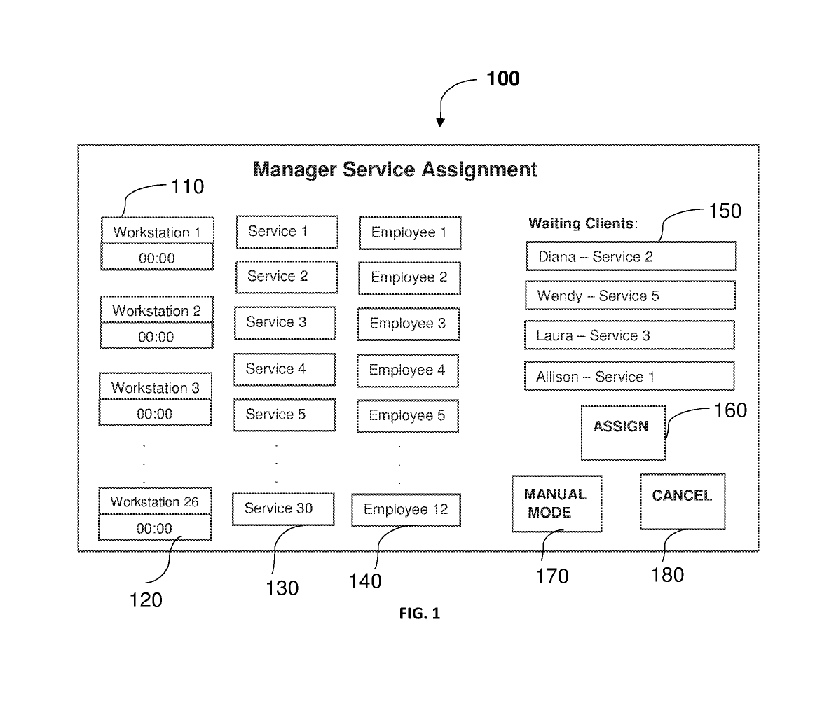

Referring now the drawings with more specificity, the present invention essentially provides for a smart timer device. The preferred embodiments of the present invention will now be described with reference to FIGS. 1-21 of the drawings. Variations and embodiments contained herein will become apparent in light of the following descriptions.

Looking now to FIG. 1 user interface 100 of manager device 400 is show. This user interface is for managers and may be displayed on a touch screen. Interface 100 includes Workstation 110 buttons, Countdown Timer 120 labels, Service 130 buttons, Employee 140 buttons, Client 150 buttons, an Assign 160 button, a Manual Mode 170 button, and a Cancel 180 button. The user interface 100 allows the user to assign services to employees and workstations, cancel services already assigned, and set mode of operation, auto or manual. Users interact with those buttons that represent workstations, services, and employees in a salon, and other buttons (Assign 160, Mode 170, Cancel 180) for operational features that perform methods disclosed in the present invention of a Service Assignment System 300.

Looking further at FIG. 1, on the far left is a column of workstations and digital countdown timers, numbering from 1 to 26 because there are 26 workstations in this exemplary salon. The next column of buttons is for services, numbering from 1 to 30 because there are 30 different type of services in this exemplary salon: pedicure, manicure, acrylic set, and the like. The next column of buttons is for employees, numbering from 1 to 12 because there are 12 employees in this exemplary salon. On the right is for clients waiting to be served and operational features of methods. In particular embodiments, to assign the service requested by client to be performed on the workstation by the employee a user just clicks button 150, clicks button Employee 40, clicks button Workstation 110, and then clicks button Assign 160. Then the user will see the appearance color of the Workstation changed in color to indicate it is now occupied, and the countdown timer 120 associated with this exemplary workstation started off at 30:00 and counting down to 00:00. To cancel an assigned service, a user just clicks Cancel button 180 and then clicks the occupied workstation 110 that was assigned for the service. To set a mode of operation, just clicking the Mode button 170: clicking it will alternate between auto and manual mode of operation.

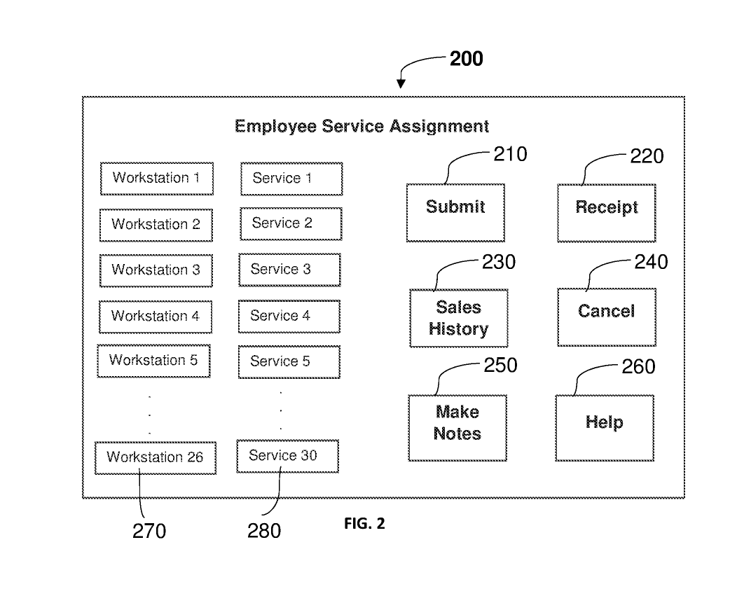

Looking now to FIG. 2, a user interface 200 of an employee device 500 is shown. This user interface 200 is for employees, it may be displayed on a touch screen of an employee device 500. The interface 200 includes workstation 270 buttons, service 280 buttons, a submit 210 button, a receipt 220 button, a sales history 230 button, a cancel 240 button, a make notes 250 button, and a help 260 button. The user interface 200 allows the user to submit a service to be performed at a workstation by the employee (the sender), cancel services already submitted, print receipts, retrieve sales history of the employee, make notes about clients, and call for help. Users interact with those buttons that represent workstations and services in a salon, and other buttons (Submit 210, Receipt 220, Sales History 230, Cancel 240, Make Notes 250, and Help 260) to perform methods disclosed in the present invention of a service assignment system 300. The underlining information of workstations, services, and employees in a salon and those operational features are programmed in an employee service assignment application 514. Methods of submitting services, printing receipts, retrieving sales history, making notes about clients, calling help, and cancelling services can also be programmed in an application.

In some embodiments, an employee just clicks the requested service 280, clicks the workstation 270 which the client is at, and then clicks submit 210, to submit a new service requested by a client. To cancel the submitted service, the employee just clicks cancel button 240 and then clicks the workstation 270 that was assigned for the service. The user interface 200 shall now allow the employee to cancel other services not assigned to the employee. After performing the service, clicking receipt 220 button prints a receipt 800. Clicking the make notes 250 button makes notes about the client just served. Clicking the help 260 button gets help from manager. To see how much the employee have made so far for the day, clicking the sales history button 230 will display the information.

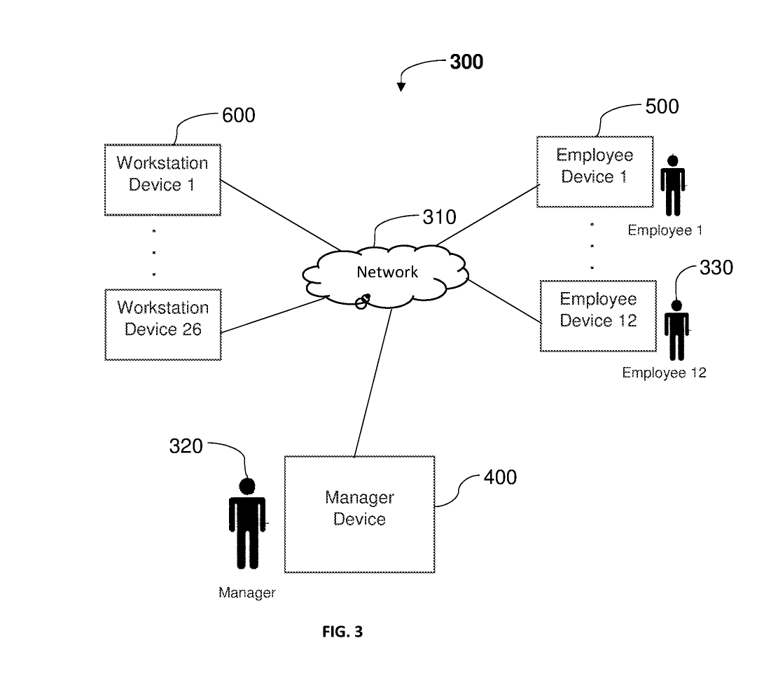

Looking now to FIG. 3 a schematic diagram of a system architecture for practicing various aspects of embodiments of the present invention is show. Service assignment system 300 is able to adapt to multiple implementations. For instance, in one embodiment, the system includes one computing device called manager device 400, multiple devices workstation devices 600, one for each workstation; employee devices 500; and routers for a WIFI communication network 310. In some embodiments, all devices 400, 500, and 600 are connected together via a network 310 using web sockets. In one embodiment, using a manager device 400, a manager 320 assigns a service to an employee 330 by sending the employee an electronic message. The employee's employee device 500 then presents the employee the message on its screen. At the same time, the manager device 400 also sends another electronic message to a workstation device 600. The workstation device 600 presents indications to the assigned employee 330 who performs the service. A manager device 400, may be a computer configured to process information, transmit and receive data across a communication.

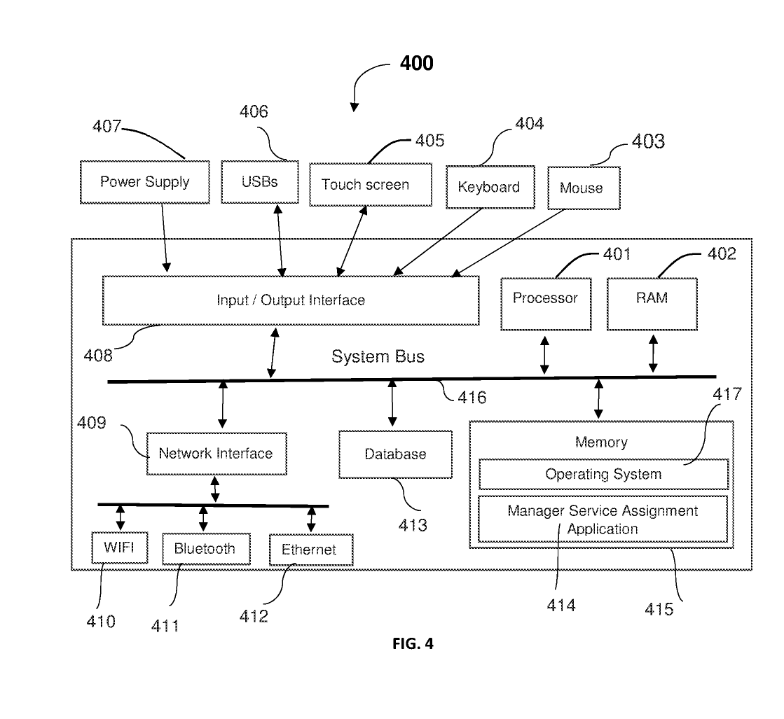

Manager device 400 is shown in FIG. 4. Manager Device 400 includes a processor 401 that communicates with other elements via a system bus 416. In certain embodiments, the processor 401 may be configured to execute computer instructions stored in the device memory or otherwise 415 accessible to the processor 401. As such, whether configured by hardware or software methods, or by a combination thereof, the processor 401 may represent an entity capable of performing operations according to embodiments of the present invention while configured accordingly. Input/output devices, such as mouse 403, keyboard 404, touch screen 405, and USBs 406, for receiving and displaying data is also included in the manager device 400. Each of these I/O devices may be connected to the system bus 416 by an appropriate Input/Output interface 408. The manager device 400 further includes memories, which may include read only memory (ROM) and Erasable Programmable Read Only Memory (EPROM) 415, and random access memory (RAM) 402. Memory 415 may include storage device(s) and its associated computer-readable media that may provide nonvolatile storage. The memory 415 described can be replaced by technologies known in the art such as embedded or removable multimedia memory cards (“MMCs”), secure digital (“SD”) memory cards, Memory Sticks, electrically erasable programmable read-only memory (“EEPROM”), flash memory, hard disk, or the like. Furthermore, a number of program modules (e.g., set of computer program instructions) may be stored by the various storage devices in memory 415 and/or within RAM 402 and/or database 413. Such program modules may include an operating system 417, a database 413, and a manager service assignment application 414. The modules 413, 414 may control certain aspects of the operation of the manager device 400 with the assistance of the processor 401 and operating system 417.

Also located within the Manager Device 400, in one embodiment, is a network interface 409 for interfacing with various computing elements. This communication may be via the same or different wired ethernet 412 or wireless networks, such as WIFI 410 and Bluetooth 411 (or a combination of wired and wireless networks). For instance, the communication may be executed using a wired data transmission protocol, such as fiber distributed data interface (“FDDI”), digital subscriber line (“DSL”), Ethernet, asynchronous transfer mode (“ATM”), frame relay, data over cable service interface specification (“DOCSIS”), or any other wired transmission protocol known to those in the art. Similarly, the manager device 400 may be configured to communicate via wireless external communication networks using any of a variety of protocols, such as 802.11, general packet radio service (“GPRS”), wideband code division multiple access (“W-CDMA”), or any other wireless protocol known to those in the art.

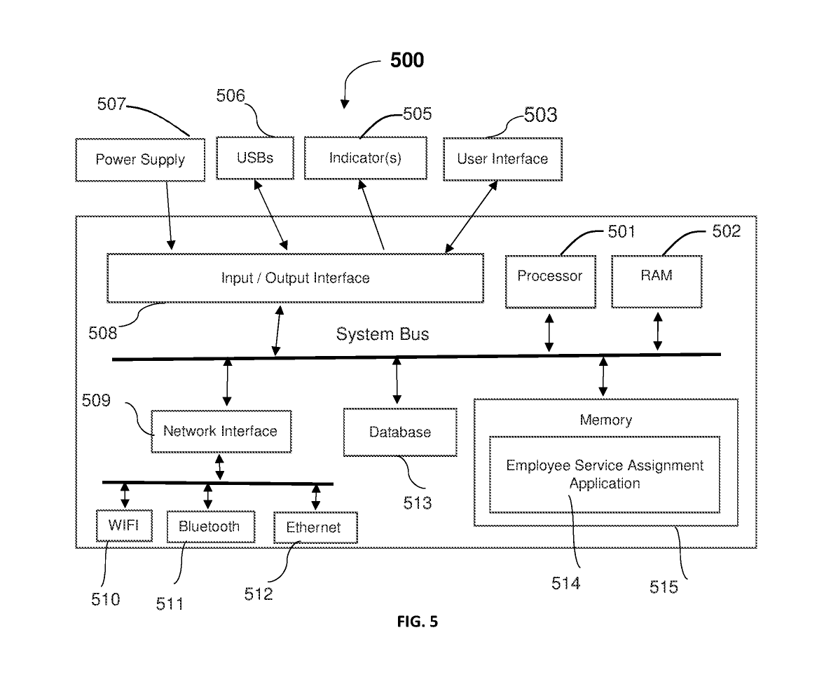

FIG. 5 shows and exemplary schematic of an employee device 500. Employee Device 500 may be any computer, computing device, desktop, notebook or laptop, handheld device, or other processing device adapted to perform the functions described herein. Employee device 500 contains an Employee Service Assignment Application 514. In particular embodiments of the present invention, the Employee Devices 500 are smart mobile phones, such as iPhones and/or Android phones. As can be seen, employee device 500 has processor 501, RAM 502, UI 503, Indicators 505, USBs 506, Power supply 507, I/O interfaces 508, network interface 509, wifi 510, Bluetooth 511, ethernet 512, database 513, employee service assignment application 514 and memory 515.

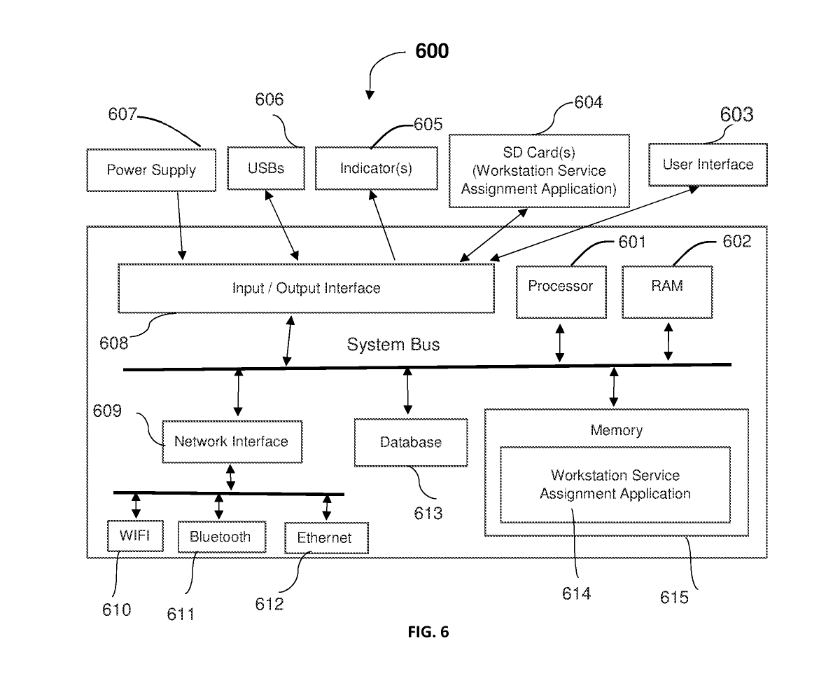

FIG. 6 shows a schematic of a workstation device 600 (aka smart timer device) according to one embodiment of the present invention. Workstation Device 600 may be any computer, computing device, desktop, notebook or laptop, handheld device, or other processing device adapted to perform the functions described herein. Workstation device 600 contains a Workstation Service Assignment Application in memory 615. Workstation devices 600 can be smart timer devices be controlled for presenting indications to employees 330 who perform services for clients. As can be seen, employee device 600 has processor 601, RAM 602, UI 603, Indicators 605, USBs 606, power supply 607, I/O interfaces 608, network interface 609, wifi 610, Bluetooth 611, ethernet 612, and database 613. In some embodiments of the present invention, the Workstation Devices 600 are smart mobile phone, such as Android phones, be controlled for presenting indications to employees 330 who perform services for clients.

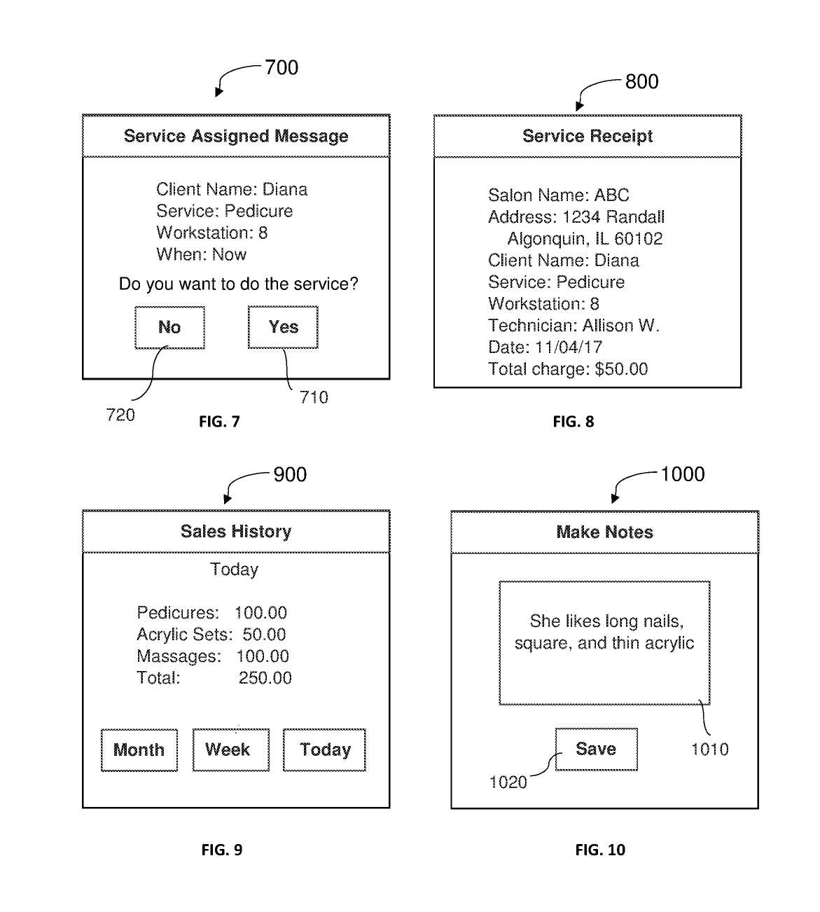

FIG. 7 shows a dialog window showing a service assignment message 700. After receiving the message 700, an Employee Device 500 will present the message to the assigned employee. The employee may reply by clicking yes 710 or no 720 buttons. An exemplary structure 1300 of a service assigned message 700 can be seen in FIG. 13. In addition, the employee device 500 may have functionality for acknowledging receipt of any messages and communicating to servers.

FIG. 8 shows a service receipt 800 showing information of the service. After receiving the receipt message, the manager device 400 may process the data and print the receipt 800.

FIG. 9 shows a dialog window showing a sales history 900 according. By clicking sales history 230 button the employee device 500 presents this user interface 900. To know how much so far the employee having made for the current month, a user can click the month button.

FIG. 10 provides a dialog window showing a make notes display 1000 To make notes about the current service for the client, users click the make notes 250 button. Then employee device 500 shall presents user interface 1000 with a text area 1010 for text editing and a save 1020 button for saving the notes. To make notes, a user types in the text area 1010 and then clicks save 1020 button.

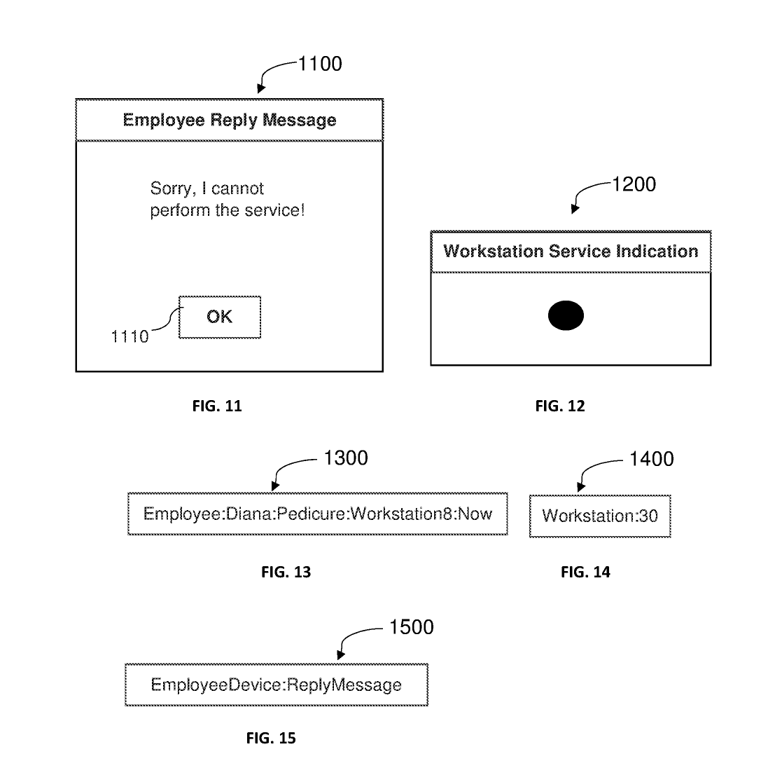

FIG. 11 shows an exemplary dialog window showing an Employee Reply Message 1100. After receiving a reply message 1500 (FIG. 15) from an Employee Device 500, a Manager Device 400 can present this user interface 1100 on its screen. Clicking OK 1110 button may close the interface 1100.

FIG. 12 provides a user interface showing a workstation service indication 1200. After receiving an indication message 1400 (FIG. 14) from a manager device 400, the assigned workstation device 600 may present this user interface 1200 to the assigned employee 330. The interface 1200, in particular embodiments, shows LED light indicating the performing time required by the assigned service 280 and a workstation device 600 may be a smart timer device.

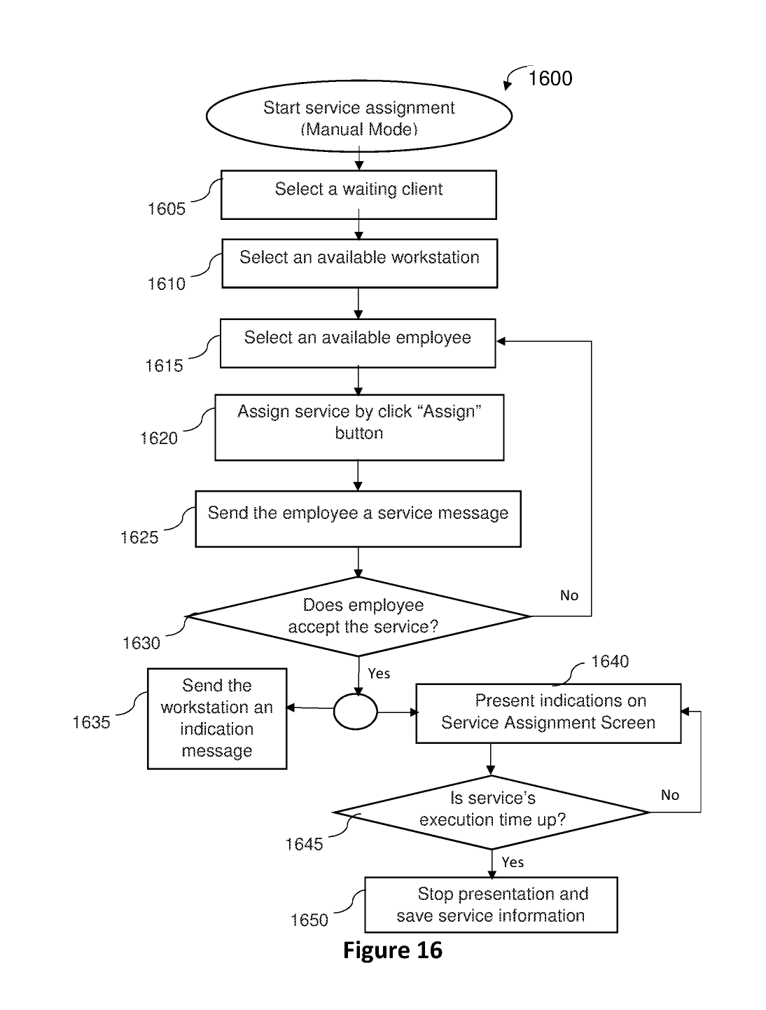

Service assignment method 1600 is shown in FIG. 16. The method entails assigning a service in the manual mode of operation: the method 1600 can be manually performed by a manager 320. This method is typically conducted on manager device 400. The first step of the service assignment method 1600 involves selecting 1605 a waiting client 150, selecting 1610 an available workstation 110, selecting 1615 an available employee 140, and then selecting 1620 assign button 160. The manager service assignment application 414 processes data generated by the selections and then sends 1625 a service assignment message 1300 to the selected employee device 500. If a reply NO received from the employee, the method is back to the step 1615 waiting for a new selected employee. If a reply YES received from the employee, the manager device 400 may send 1635 a service indication message 1400 to the selected workstation's workstation device 600, while presenting 1460 indications on the selected workstation 110 button and starting the countdown timer 120 associated with the workstation 110. If the countdown timer 120 is still running 1645, the manager service assignment application 414 continues to presenting indications and the timer 120 still displaying time remaining. If the performing time required by the selected service is up, the manager service assignment application 414 stops the presentation 1650: the countdown timer 120 stopped at 00:00 and the selected workstation button's color changed back to default color (for example, green to red) from the working color. Finally, the manager service assignment application 414 saves data related to the assigned service.

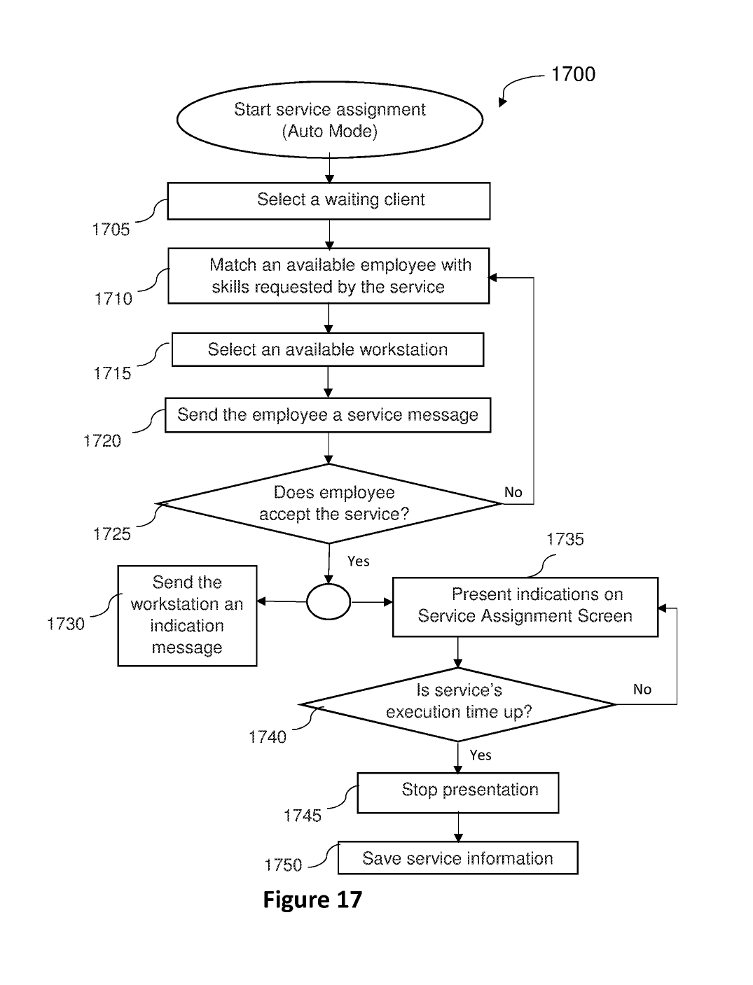

Service assignment method 1700 is shown in FIG. 17. The method entails assigning a service in the auto mode of operation: the method is automatically performed by the manager service assignment application 414 itself, in absence of a manager 320. This method is processed by a manager device 400 with supports of processor 401 and a manager service assignment application 414. The first step of the service assignment method 170 involves selecting 1705 a waiting client 150, matching 1710 an available employee 140 with the skills required by the requested service 130, selecting 1715 an available workstation 110. The manager service assignment application 414 processes data generated by the selections and then sends 1720 a service assignment message 1300 to the selected employee's employee device 500. If a reply NO received 1725 from the employee, the method is back to the step 1710 for another available employee matching. If a reply YES received 1725 from the employee, the manager device 400 may send 1730 a service indication message 1400 to the selected workstation's workstation device 600, while presenting 1735 indications on the selected workstation 110 button and starting the countdown timer 120 associated with the workstation 110. If the countdown timer 120 is still running 1740, the manager service assignment application 414 continues to presenting 1735 indications and the timer 120 still displaying time remaining. If the performing time required by the selected service is up, the manager service assignment application 414 stops the presentation 1745: the countdown timer 120 stopped at 00:00 and the selected workstation button's color changed back to default color, green, from the working color, red, for example. Finally, the manager service assignment application 414 saves 1750 data related to the assigned service. Note: at the same time, the workstation device 600 may do the same: stopping presenting indications to the assigned employee and going back to normal stage.

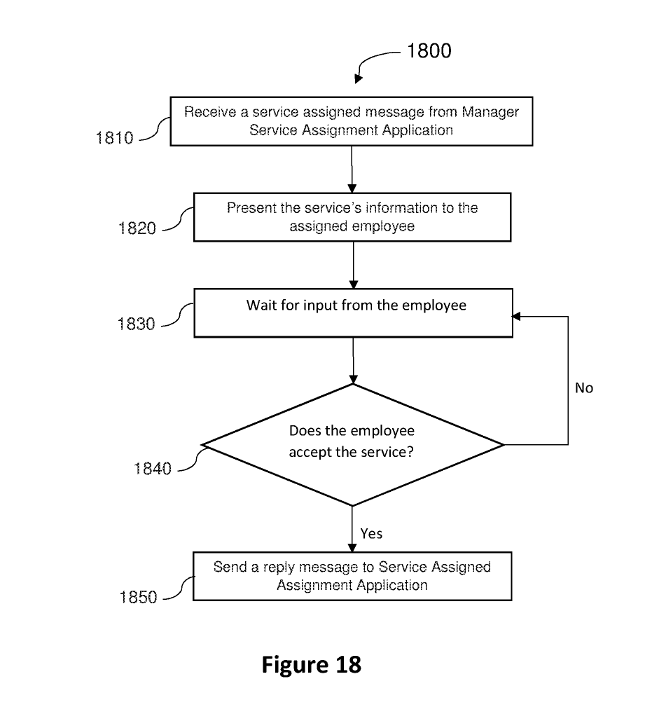

FIG. 18 a method 1800 of an employee receiving a service assigned message. The method 1800 entails receiving a service assigned message 1300. This method is processed by an employee device 500 with supports of processor 501 and an employee service assignment application 514. The first step in receiving service assignment method 1800 involves an employee device 500 receiving 1810 a service assigned message 1300 from a manager device 400 containing a manager service assignment application 414. After processed the received message, the employee service assignment application 514 presents 1820 the service information, service assigned message 700, to the employee on the user interface 503 of the employee device 500. The employee service assignment application 514 then waits 1830 for input from the employee. If the input is No 720 received 1840 from the employee, the employee service assignment application 514 sends a no reply message to the manager device 400 that will presents the message 1100 on a user interface 405. If the input is Yes 710 received 1840 from the employee, the employee service assignment application 514 sends a Yes reply message to the manager device 400 that then will continue with step 1630 in FIG. 16, if in manual mode or step 1725 in FIG. 17, if in auto mode.

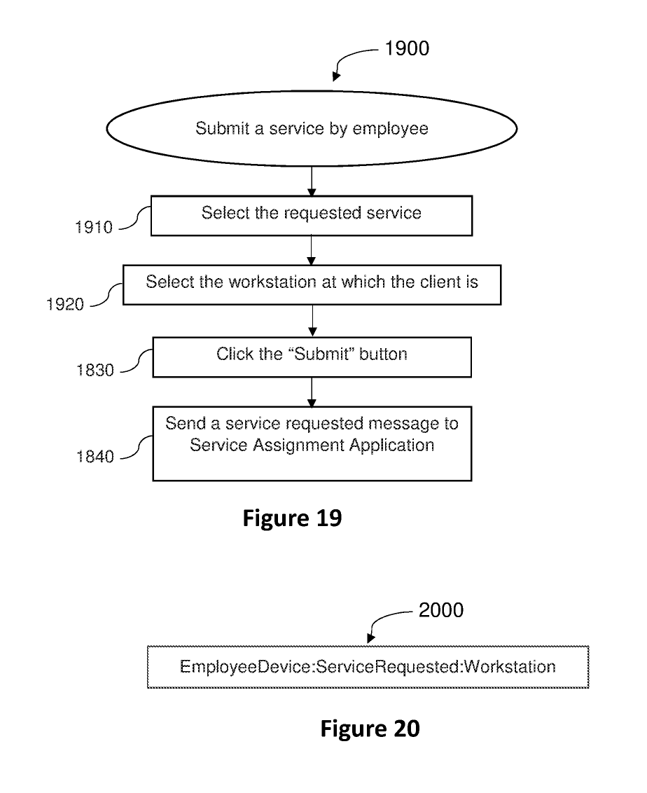

FIG. 19 displays a method of submitting a service requested by a client by an employee. The method entails submitting a service from an employee device 500 to a manager device 400 by a user, an employee for example, having an employee device 500. The first step of submitting a service 280 by an employee 330 involves selecting 1910 the requested service 280, selecting 1920 the workstation 270, and clicking the Submit 210 button. Packing the data generated from these selections into a service requested message 2000 (as shown in FIG. 20), the employee service assignment application 514 may send the message 2000 to a manager device 400 that then processes 2100 the message just received.

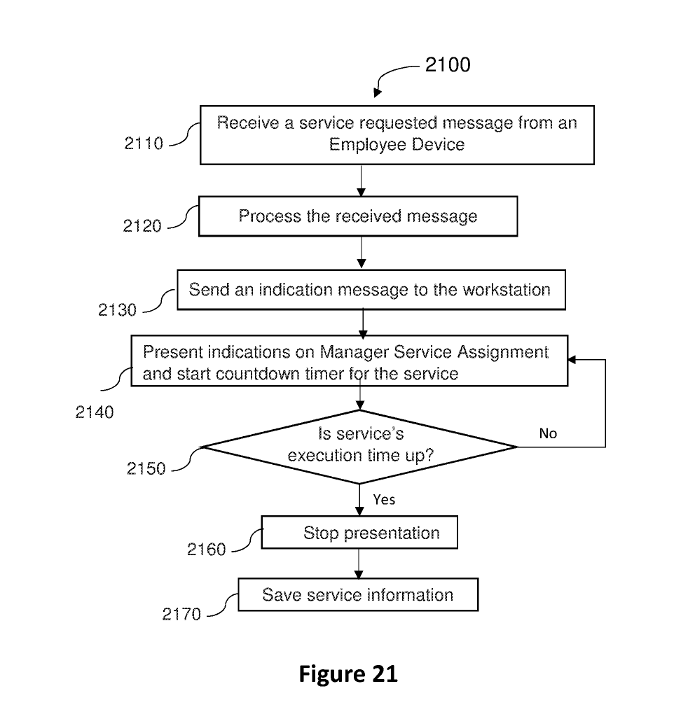

FIG. 21 shows a method of receiving a service requested message from an employee device 500. The method 21000 entails a manager device 400 receiving a service requested message from an employee device 500. The first step of the method 2100 involves receiving 2110 a service requested message 2000 sent by an employee device 500 via a communication 310. After receiving the message 2000, the manager service assignment application 414 processes 2120 by unpacking it into more useful information, such as employee device, service requested, workstation number. Next, after packing available data into a workstation service indication message 1400, the manager service assignment application 414 sends 2130 it to the workstation device 600. Then the manager service assignment application 414 presents 2140 indications on the workstation 110 by changing its color from default color, green, to working color red, for example. And the manager service assignment application 414 starts running the countdown timer 120 associated with this workstation 110. If the timer 120 stopped and the clock is 00:00 (performing time required by the service is up), the manager service assignment application 414 stops 2160 the presentation and save 2170 related service information into database 413 and/or memory 415 of manager device 400.

### INDUSTRIAL APPLICABILITY AND CONSTRUCTION

In an aspect of the present disclosure may be implemented in various ways, including as methods, apparatuses, systems, or computer program products. Accordingly, the embodiments may take the form of an entirely hardware embodiment or an embodiment in which a processor is programmed to perform certain steps. Furthermore, the various implementations may take the form of a computer program product on a computer-readable storage medium having computer-readable program instructions embodied in the storage medium. Any suitable computer-readable storage medium may be utilized including hard disks, CDROMs, optical storage devices, magnetic storage devices or other comparables known in the art.

The computer program instructions or codes for carrying out methods or operations for aspects of the present disclosure may be written in any combination of one or more programming languages, including an object oriented programming language such as Java, C++, C# or the like and conventional procedural programming languages, such as C or others known in the art. The computer program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The indicators 505 include, but are not limited to, LEDs, displays, and touch screens.

The communication network 310 includes, but not is not limited to, WIFI, Bluetooth, Ethernet, and cellular networks.

The memory cards include, but are not limited to, SD cards, ROM, and RAM. The user interface includes, but is not limited to, switches, touch screens, and sensors.

The power supply includes, but is not limited to, AC-DC power adapter, and batteries.

In some aspects of the invention, the present invention is embedded in a housing making out of wood, plastic, or metal.

In an embodiment of the invention, if users want to have the present invention's system with a touch screen, the system is implemented on a mobile phone device. In some embodiments, visual indication presented includes images, icons, clips, and other implementations known in the art.

In certain embodiments of the invention, an exemplary service message 700 includes, at least a value in time (hour, minute, second, or millisecond. Further, an exemplary service message includes at least a value in time (hour, minute, second, or millisecond) combined with text characters. Further in some embodiments, an exemplary service message is packed (embedded) in a pre-defined format.

In another embodiment of the invention, computer application 414 is written in computer programming languages such as, but not limited to, C, C++, Java, C#, Linux, Unix, JavaScript, Html, sketch (Ardunio). And operating system includes, but not limited to, ubuntu, Linux, Red Hat, vustom real time operating system (RTOS). Processor includes, but not limited to, PowerPC, Intel, AMD, Texas Instruments, ARM, Espressif.

Various times of service (15, 30, 60 minutes) are well used as well as various salon configurations (such as 36 stations) these, and other implementations well known in the art can be preprogrammed as well as allowing for customizable options.

Accordingly, although the invention has been described by reference to certain preferred and alternative embodiments, it is not intended that the novel arrangements be limited thereby, but that modifications thereof are intended to be included as falling within the broad scope and spirit of the foregoing disclosures and the appended drawings.

I claim:

1. A service assignment network comprising:
a manager device, the manager device housing a manager service assignment application, and the manager service assignment application allowing a manager to select a client, a workstation, an employee, and a service and communicate the selections to the service assignment network; and
an employee device in communication with the manager device, the employee device housing an employee service assignment application, the employee service assignment application allowing an employee to accept or reject selections made by the manager service assignment application, and the employee service assignment application causing the employee device to provide visual indicators to indicate whether the service has been completed.

2. The service assignment network of claim 1 further comprising:
a workstation device in communication with the manager device and the employee device, the workstation device housing a workstation service assignment application, the workstation service assignment application, the workstation service assignment application allowing the workstation device to display visual indicators to indicate whether the service has been completed.

3. The service assignment network of claim 2 wherein:
the employee device is a plurality of employee devices, and
the workstation device is a plurality of workstation devices.

4. The service assignment network of claim 2 wherein:
the workstation contains a processor with memory connected to a transceiver and visual indicator, a, device drivers, programming, wherein the visual indicator is a user interface and a display device, and wherein the transceiver is a communication network interface.

5. The service assignment network of of claim 4 wherein the workstation device is a smart timer device.

6. The service assignment network of claim 2 wherein:
the employee device and the workstation device are synchronized to provide identical visual indicators until the service is completed.

7. A method for assigning services comprising:
starting service assignment mode;
selecting an available workstation using a manager device;
selecting an available employee on the manager device;
assigning a service to the employee on the manager device;
sending a service message to the employee on the employee device, the service message inquiring whether the employee accepts the service, the employee selecting from the group consisting of: Yes and No;
returning to selecting an available employee in the event the employee selects: No;
sending the workstation an indication message;
presenting indications on a service assignment screen on the employee device;
inquiring whether service execution time has expired;
stopping presentation and saving service information if service execution time has expired.

8. The method of claim 7 wherein:
a manager manually manipulates the manager device.

9. The method of claim 7 wherein:
the manager device automatically makes selections and assignments based on information stored in a manager service assignment application.

10. The method of claim 7 further comprising:
generating a service receipt.

11. The method of claim 10 wherein:
the service receipt contains information including client, service, workstation, employee, and charge information.

12. The method of claim 7 further comprising:
making notations on a notation screen on the employee device after service; and
saving said notations to a database.

13. The method of claim 12 wherein:
notations are assigned to client information and retained for future service.

14. The method of claim 7 wherein:
presentation is done on a touchscreen.
